(19) United States
(12) Patent Application Publication
(10) Pub. No.: US 2012/0242817 A1
(43) Pub. Date: Sep. 27, 2012

(54) SYSTEM AND METHOD FOR IDENTIFYING A PATHOLOGICAL TISSUE IMAGE

(75) Inventor: WILLIAM PAN, TAIPEI CITY 105 (TW)

(73) Assignee: EBM TECHNOLOGIES INCORPORATED, TAIPEI CITY 114 (TW)

(21) Appl. No.: 13/483,210

(22) Filed: May 30, 2012

Related U.S. Application Data
(63) Continuation-in-part of application No. 12/346,085, filed on Dec. 30, 2008.

(51) Int. Cl. H04N 7/18

(52) U.S. Cl. 348/77; 348/E07.085

(57) ABSTRACT

Disclosed are a system and a method for identifying the pathological image based on the interested regions of the pathological tissue image. In the system, a memory stores the instructions for performing the method. The step in the method includes using an optical microscope to capture an image of a pathological section, and one of the observation regions is selected from the pathological section image as to be an original symptom image. Then a region of interest (ROI) is selected from the original symptom image. For generating a magnified tissue image with a matching magnification, the ROI is enlarged. A scan operation is performed onto the magnified tissue image for conducting a comparison process. Coordinates for identifying the magnified tissue image in the original symptom image can be acquired by the comparison process.

### CROSS-REFERENCE TO RELATED APPLICATIONS

This application is a Continuation-in-Part of application Ser. No. 12/346,085, filed on 30 Dec. 2008, and entitled STORAGE SYSTEM FOR STORING THE SAMPLING DATA OF PATHOLOGICAL SECTION AND METHOD THEREOF, currently pending.

### BACKGROUND OF THE INVENTION

1. Field of the Invention

The present invention relates to a system and a method for identifying pathological image based on the interested regions thereof; in particular, the system uses scanning and matching means to retrieve the interested image by extracting the features.

2. Description of Related Art

As computer technologies advance, digitalization of medical information and management of high efficiency thereof have now become important and necessary trends. Conventionally, medical data of patients are displayed on physical documents by doctors (e.g. medical history data in the form of papers and file folders, X-ray films and the like), which occupy large storage space and consume huge amount of resources such as manpower, capital investment for archiving processes. Presently, it is possible to use computer technologies to perform systematic management on medical data by means of database, in conjunction with data transfer over computer network, allowing more effective transition and utilization of the entire medical data, which provides significant progress and efficiency on service quality of patient medication as well as medical affair management for hospitals.

Besides, demand for medical images on clinical diagnosis applications also increases. Many medical instruments offer digitized medical data, but still large portion therein are not stored in standardized digital formats. However if a standardized digital formats can be agreed upon, the exchange of digital medical data in standardized formats between different hospital information systems becomes possible, which facilitates deployment of medical resources and enhancement of medical operation efficiency. DICOM (Digital Imaging and Communication in Medicine) standard is one commonly used standard for medical image exchange nowadays, which provides definitions concerning waveform information objects, allowing digital medical images from various medical units to have a common imaging standard for mutual exchange and transfer.

At the same time, traditional microscopes are still very widely used in medical academies, schools, nursery, and caring facilities, instead of electronic microscopes, as tools for micro observations. Physicians and nursery personnel need to request patients for body tissue sampling (i.e. biopsy), making tissue sections (sometimes also referred to as pathological sections) then using optical microscopes for micro observation and verification.

However, after enlargement of tissue image, in case of lacking relevant supportive information such as relative coordinate, enlargement multiplicities and so on, it becomes meaningless graphics, thus impossible to revert to original state as understandable tissue image information.

### SUMMARY OF THE INVENTION

In view of the aforementioned issues, the present invention provides a storage system for sampling data of pathological section, and also a system and related method for identifying the tissue image by conducting the similarity determination based on the interested regions of pathological tissue image. The system takes variously magnified tissue images from the pathological section, and compares respectively each of the variously magnified tissue images with the original image enlarged to the same degree of magnification (the original symptom image enlarged with the same magnification as the tissue image currently being compared, a.k.a. original image with matching magnification).

The system generates coordinates of the variously magnified tissue images corresponding to the original symptom image, then integrates and stores the variously magnified tissue images and their corresponding coordinates into a sampled data (i.e. the sampled data of pathological sections), which allows physicians to explicitly appreciate the position of the magnified tissue images in the original symptom image when viewing the tissue images, facilitating fast biopsy analysis.

In one aspect of the invention, a method for identifying a pathological tissue image is disclosed. The steps in the method includes using an optical microscope to capture an image of a pathological section, selecting one of the observation regions from the pathological section image to be an original symptom image. The method is allowed to make selection of an area including a region of interest (ROI) from pathological section. The area in connection with the concerned ROI is enlarged for generating a magnified tissue image with a matching magnification. A scan operation is performed onto the magnified tissue image for conducting the further comparison process. The comparison is performed between the magnified tissue image with the magnified original image from the original symptom image with the matching magnification. Approximate coordinates of the magnified tissue image in the original symptom image can be acquired, and this coordinates is set as the coordinates of the magnified tissue image. The tissue image is therefore identified.

The summary illustrated supra and detailed descriptions set out infra are simply for illustrative purposes, which further describe the claimed scope of the present invention. Other objectives and advantages of the present invention will be explained in the following illustrations and appended diagrams.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a series of steps illustrating the process of image sampling and storing according to the present invention;

FIG. 2 shows the schematic diagrams illustrating the aspects to identify the image in accordance with the present invention;

FIG. 3 is a block diagram of the storage system for sampling data of pathological section according to the present invention;

FIG. 4 is a flowchart illustrating a main process of generating the final interesting images according to the present invention;

FIG. 5 is a flowchart of inquiry based on the method in accordance with the present invention.

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

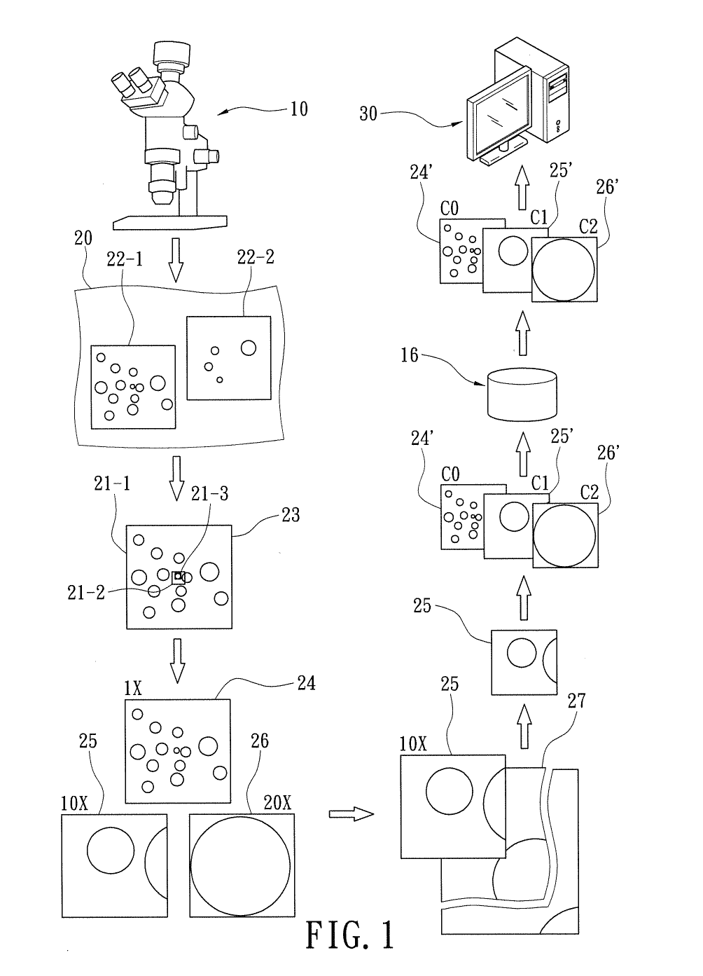

Refer now to FIG. 1, a flowchart is shown to illustrate the steps of sampling data of pathological section (i.e. biopsy). The related processes for performing the target selection, features extraction, comparison, similarity determination and coordination calculation within the flowchart shown in FIG. 1.

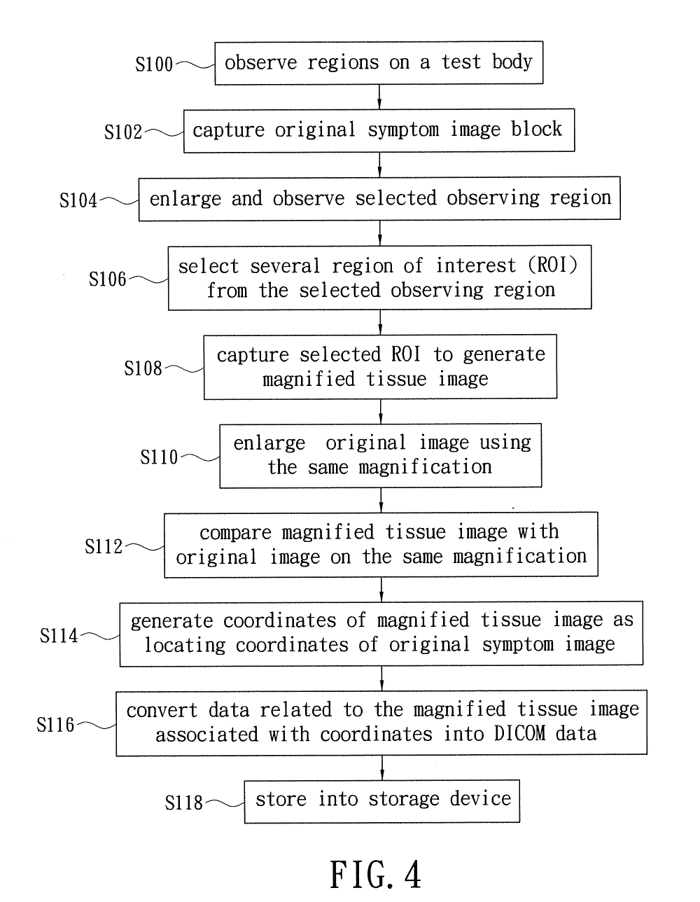

In FIG. 1, in view of a flow described in FIG. 4, first of all, an imaging microscope 10, preferably an optical microscope, is selected. A pathological section 20 obtained from a patient is placed on an observation stage of the imaging microscope 10. Using an optical microscope, a user may thereby observe regions on a test body (S100). The pathological section 20 serves as the test body on which a pathological section such as tissue section of a human tissue, blood, bacteria, or excrement is obtained. Then, the method may select one of the observation regions obtained by the optical microscope, such as the shown regions 22-1, 22-2, from the pathological section 20. The imaging microscope 10, preferably the optical microscope, is used to observe the images with respect to the selected observation regions 22-1, 22-2, and one of the them is to be captured as an original symptom image 23 (S102). In an exemplary example, a digital camera may be used to take some key images from the pathological section 20, and one of the images may be served as the original symptom image 23 according to a user's decision. The pathological section 20 includes the observation regions 22-1, 22-2 observed by the optical microscope. So far the observation regions 22-1, 22-2 are not digital images before digitizing them into the digitized original symptom image 23.

The original symptom image 23 is captured manually using a digital camera as a digital image for further image processing. Next, the method is allowed to conduct enlarging, observing selected observing region and then selecting an area having a concerned region of interest (ROI) 21-1 from the observation region 22-1 which is selected form the pathological section (20) (S104). In step S106, the areas selected to have the several regions of interest (ROI) from the selected observing region 22-1 are processed to generate magnified tissue image 25 (S108). In which, the area having the ROI can be directly taken from the pathological section (20) used to acquire the observation regions 22-1, 22-2 when the ROI is identified as observing the pathological section 20 with a specified magnification. For example, the pathological section is observed with 10× (but not limited) magnification, the camera is used to take the image if ROI is found.

It is noting that, even though by the microscope with one-time magnification, merely a small portion of the pathological section can be observed at a time. Further, the electronic microscope may completely retrieve the whole image of the pathological section since it operates sequentially over the whole section. However, the optical microscope used in the present invention may spend several times to observe and capture the different observation regions such as the shown regions 22-1, 22-2 by manual manipulation. It is noted that, for example, both the region 22-1 and the image 23 include the ROIs, and may not be identical since the region 22-1 is manually retrieved.

As FIG. 1 shows, subsequently, the method enlarges the original symptom image 23 into the original image 27 with a matching magnification (which means, original image 27 has a 1× magnification when matched against original symptom image 24; a 10× magnification when matched against 25; a 20× magnification when matched against 26 according to above-described magnification). In other words, original image 27 with matching magnification currently has 1× magnification. Furthermore, it should be noted that “the original image with matching magnification” is the same as “the original symptom image with matching magnification”. Therefore, once the original symptom image has been defined, an article “the” then can be used with “the original image with matching magnification”. Thus herein the original symptom image 23 is enlarged by 1× into the original image 27 with matching magnification. Then, a software program is executed to perform a scan operation (e.g. scanning from left to right and from top to bottom) onto the acquired 1× magnified tissue image 24. The method next compares it with the magnified original image 27 with matching magnification (S110) for further finding out the approximate coordinate C0 of the 1× magnified tissue image 24 in the original image 27 with matching magnification (S112). The method then sets this coordinate C0 as the corresponding image coordinate C0 of the 1× magnified tissue image 24 in the original symptom image 23. That is, the coordinates can be determined if the region including the ROI with a specific magnification is matched with the original symptom image. Such as the step S114, the coordinates of the magnified tissue image is generated as locating the original symptom image.

In company with the above selected area with the ROI, the method also provides a feature that allows the user to select another ROI 21-2 (requires 10× magnification) and ROI 21-3 (requires 20× magnification) on the original symptom image 23. Then, based on the required magnification, the method is to enlarge the selected ROI 21-2 and ROI 21-3, and to generate the magnified tissue images 25 and 26 respectively (S106). As such, FIG. 1 shows the 10× magnified tissue image 25 and 20× magnified tissue image 26.

Referring again to FIG. 1, according to the aforementioned 10× and 20× magnifications, the method is to enlarge the original symptom image 23 to respectively generate the original images 27 with respective matching magnifications (original image 27 has a 10× magnification when matched against original symptom image 25; has a 20× magnification when matched against original symptom image 26 [not shown in FIG. 1]). Then, a software program is used to perform a scan process onto the acquired 10× magnified tissue image 25 and compare with the original image 27 with matching magnification (10× magnification of original symptom image 23) for further finding out the approximate coordinate C1 of the 10× magnified tissue image 25 in the original image 27 with matching magnification (S110, S112), and setting this coordinate C1 as the corresponding image coordinate C1 of the 10× magnified tissue image 25 in the original symptom image 23. In the same way, the software program is again executed to perform a scan operation onto the acquired 20× magnified tissue image 26 and compare with the original image 27 with matching magnification (20× magnification of original symptom image 23) for further finding out the approximate coordinate C2 of the 20× magnified tissue image 26 in the original image 27 with matching magnification (S110, S112), and setting this coordinate C2 as the corresponding image coordinate C2 of the 20× tissue image 26 in the original symptom image 23.

It is noting that, rather than the modern technology using an electronic microscope to conduct the symptom analysis, the optical microscope adopted to implement the flow shown in FIG. 1 is much difficult and requires more effort onto the image processing. Moreover, through the above-mentioned processes, it is possible to generate variously magnified tissue images 24, 25, 26, which respectively correspond to the image coordinates C0, C1, C2 in the original symptom image 23.

In FIG. 1, after respectively comparing the 1× magnified tissue image 24, the 10× magnified tissue image 25 and the 20× magnified tissue image 26 with the original symptom image 23, it is possible to acquire the corresponding image coordinates C0, C1, C2 in the original symptom image 23. Next, the method is to convert each magnified tissue images 24′, 25′, 26′ having respective image coordinate C0, C1, C2, along with information such as patient name, gender, medical history number, image name, and magnification into a sampling data D1 in DICOM format (S116). Finally, based on the compression or non-compression requirement, store the sampling data D1 in a file with DICOM format in a storage device 16 (S118) for physicians' reference.

In one exemplary example, when a doctor needs to examine the sampling data D1 stored in the storage device 16, he/she only has to perform simple search condition input based on characters in the pathological section 20, including inquiry conditions like patient name, medical history number, . . . etc. in order to retrieve the sampling data D1 corresponding to the pathological section 20 from the storage device 16. After processes of conversion, decompression on the retrieved sampling data D1, it is possible to generate each magnified tissue images 24′, 25′, 26′ having respective image coordinate C0, C1, C2, along with information like patient name, gender, medical history number, image name, magnification and so on (S202). Doctors may use a terminal computer 30 to access each of the aforementioned magnified tissue images 24′, 25′, 26′ having respective image coordinate C0, C1, C2 and information such as patient name, gender, medical history number, image name and magnification, so as to clearly appreciate the relative positions of variously magnified tissue images 24, 25, 26 in the original symptom image 23, facilitating quick biopsy analysis and thus improving medical treatment quality. Meanwhile, physicians may also perform operations like editing, adjustment, browsing on various kind of aforementioned information.

Furthermore, during the process to identify the tissue image, a calibration process is introduced to calibrating the images with essentially consistent magnification and alignment, especially for the step of comparing. The consistent magnification and alignment of both images allow the following comparison more convenient. Some other calibrations such as to calibrate color, clearness, noise, and orientation of the image.

The images undergoing the comparison process may have different magnifications, and one of them may need to be shrunk or enlarged. While the images are magnified, the magnified images need to be inserted with extra pixels, for example by an interpolation process.

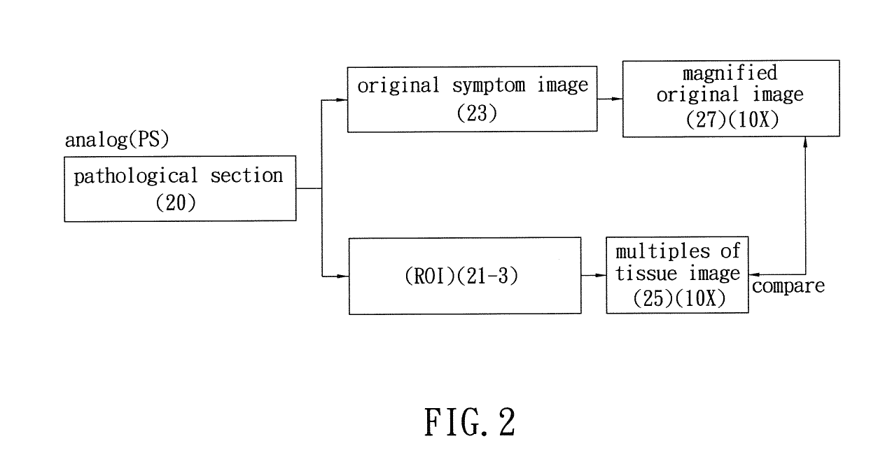

FIG. 2 shows a schematic diagram illustrating one of the aspects of the present invention.

Firstly, an analogic image, such as the pathological section (PS, 20), observed and selected by the optical microscope. This analogic image is converted into an original symptom image (OSI, 23), preferably taken by a digital camera. The digital image is served for obtaining its coordinates by the above-described comparison process. Next, an area having the ROI (21-3), which is concerned in the process, is selected from the analogical pathological section (20). For example, a user manually manipulates the optical microscope and chooses a region of tissue, which is the area including and specifying the ROI. This area may next be converted into a digital image when it is captured by a digital camera.

The digital image of the selected area with the ROI can be conveniently used to acquire its coordinates. In the meantime, an original image 27 with a matching magnification, for example 10× magnification, is also provided by enlarging the original symptom image (23). In the process, the multiples of tissue image (25) can be obtained by enlarging the area with the ROI. Then the coordinates of the magnified tissue image 25 in connection with the area having the ROI (21-3) can be identified by conducting a comparison process with the magnified original image 27.

It is noted that when the ROI is chosen, the region surrounding the ROI may be magnified by adjusting the microscope, the region may include the area bigger than the area occupied ROI.

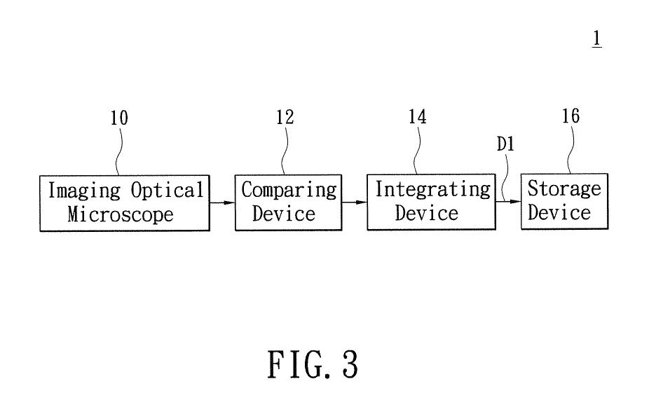

Reference is made to FIG. 1, in view of FIG. 2, and now to FIG. 3. FIG. 3 shows a block diagram having some essential components of the system which performs a digitization of the sampling data of pathological section. In an exemplary embodiment, a system 1 for performing the above-referenced method is disclosed. The system 1 for identifying the pathological tissue image is such as a computer-implemented system which includes a processor for performing a series of instructions of similarity determination of interested regions of pathological tissue image. The instructions are such as the codes stored in a memory of the system 1. The system 1 includes an imaging microscope (such as the imaging optical microscope 10) which is used to observe the tissue image and the original health image, and serves to select the target zone and the features. A comparing device 12, which is coupled to the imaging microscope 10, is included in the system 1 and allowing the system 1 to perform the features comparison and then generate corresponding image coordinates. The system 1 further includes an integrating device 14, which is coupled to the comparing device 12, for integrating the tissue image and the corresponding coordinates into a sampling data. The system 1 has a storage device 16 being the storage for storing the coordinates of the matched target zone.

Herein the system 1 uses the imaging optical microscope 10 to take an original symptom image 23 from the pathological section 20, and selects a ROI from the analogous pathological section 20 and enlarges the selected ROI to generate each magnified tissue images 24, 25, 26. The comparing device 12 is coupled to the imaging optical microscope 10, and the comparing device 12 uses the software program to scan in order to compare each magnified tissue images 24, 25, 26 against the original image 27 with matching magnification, in order to respectively finding out the approximate coordinate C0, C1, C2 of the magnified tissue images 24, 25, 26 in the pathological section 20. The comparing device 12 further sets the coordinate C0, C1, C2 as the corresponding image coordinate C0, C1, C2 of each magnified tissue images 24, 25, 26 in the original symptom image 23. The integrating device 14 is coupled to the comparing device 12, wherein the integrating device 14 individually integrates the generated magnified tissue images 24, 25, 26 with the image coordinate C0, C1, C2, in conjunction with information such as patient name, gender, medical history number, image name, and magnification, so as to convert all the information into a sampling data D1 in DICOM format. Then, based on the compression or non-compression requirement, it stores the sampling data D1 in a storage device 16 of the integrating device 14, wherein the storage device 16 is a database.

For example, when a doctor needs to examine the sampling data D1 stored in the storage device 16, the doctor only has to perform simple search condition input based on characters in the pathological section 20 to retrieve the sampling data D1 corresponding to the pathological section 20 from the storage device 16. After processes of conversion, decompression on the retrieved sampling data D1, it is possible to generate the original symptom image 23 and respective image coordinate C0, C1, C2 of the pathological section 20 (FIG. 1), along with information like patient name, gender, medical history number, image name, magnification and so on, allowing doctors to explicitly appreciate the relative positions of variously magnified tissue images 24, 25, 26 in the original symptom image 23 (FIG. 1), facilitating quick biopsy analysis and thus improving medical treatment quality. At the same time, physicians may also perform operations like editing, adjustment, or browsing on various kind of aforementioned information.

In summary of the above-stated descriptions, the system for determining similarity and storing sampling data of pathological section uses the comparison of variously magnified tissue images and the original image with matching magnification to acquire the corresponding image coordinate of variously magnified tissue image in the original symptom image, then respectively integrates the variously magnified tissue images and the corresponding image coordinate thereof into a sampling data. As such, when a doctor is viewing the tissue image, he/she may only need to perform simple search operations, and the computer system can be instructed to obtain the entire group of tissue images and coordinates thereof of the specific patient from the database. After reconstruction processes through computer program operations, each image and respective relevant position can be shown on a computer screen in an understandable way. Furthermore, physicians may merely depend on each tissue images and respective relevant coordinate to manually create an understandable reference images without computer process, so as to facilitate quick diagnosis on patients and improve medical treatment quality accordingly.

The above-mentioned image coordinates made by the matching process are used to identify the location of image, especially the interested pathological tissue image. The ROI is selected by a user from the original symptom image is the interested region with the coordinates desired to be stored into the storage.

The method in accordance with the present invention is preferably applicable to the medical image recognition. The method for processing the medical images is allegedly not a simple work since the medical images are various to cover a very wide range of applications. Therefore, some critical technologies of image processing are incorporated into the invention.

A pre-processing stage of the method incorporates a target image and a control image. In an exemplary embodiment, the target image is indicative of a tissue image implementing an experimental image, and the control image is indicative of an original health image or the mentioned original symptom image. This control image is served to make a comparison with the target image in order to acquire the corresponding coordinates.

Furthermore, the method may further convert the date regarding the tissue image associated with the matched coordinates into DICOM standard data. DICOM format data is a well-known format used for storing the medical images. The tissue image associated with the matched coordinates stored in the storage may also be accompanied with a related patient name, gender, medical history, image title, and the data relevant to the image can be integrated into the DICOM-format file.

Rather than the pre-arrangement process operated onto the image beforehand and used to improve the image quality in the conventional technology, it is noted that the invention identify the image by the matching process using the selected features. In which, the features selected from the image are such as the blocks of dark and light areas, or organ sections. For example, human face, facial shape, and color may be the features to be selected. Also, geometric characteristics of blood vessels, nerves, and cells may be the features.

In an exemplary example, an Artificial Neural Network is one of the technologies for searching the feature in the image that is adopted by the present invention. Further, a detection of the image edge may be used to acquire the features by recognizing the geometric shapes. Still further, the unique numerical characteristic of the image may be the clue for performing the feature searching. The feature value may be obtained by some further conventional algorithms, such as Hough Transform or Regression Analysis performed onto the tissue image. A distance from feature space (DFFS) may be one of the tools for evaluating the variation between the original image and the reproduced image. A principal component analysis (PCA) may be one of the ways to describe the image using feature vector with lower dimensions.

While the optical microscope is incorporated to implementing the system for the identification of image by conducting similarity determination of the interested regions of pathological tissue image, the identification of the features captured by the microscope is complicated. Provided are the approaches for performing comparison between the target image and the control image.

Since the features selected in both the target image and the control image may form some vectors depicted on the diagram, the comparison based on the vectors may be used. The vector-based comparison is based on the distances and included angles calculated among the vectors. In an example, both the distances and the angles may be the evidences to conduct the similarity determination, and preferably the average value of the distances and the angles may be introduced to performing the comparison.

Next, a geometric comparison may be used to conduct the similarity determination. The geometric distance may evaluate the differences of the features as matching the positions. The vector-based diagram may serve the geometric comparison.

Hamming distance may be one of the skills to conduct the comparison. Hamming comparison is used to determine the different components of the vectors indicative of the features for both the target image and the control image. The differences of the vectors there-between can be used to determine the similarity.

In one further aspect, the target image and the control image may be divided into several zones. The zones are adopted to compute an entropy for identify the features.

Furthermore, the similarity between the target image and the control image may be determined based on either the distance of the two ends of two selected vectors for both images, or the included angles between the two vectors.

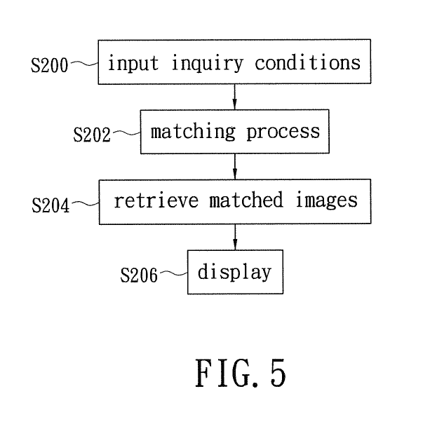

FIG. 5 shows a flowchart of inquiry based on the method in accordance with the present invention. The above-referenced storage can be a database established for users to make search. The system allows users to input inquiry conditions (step S200), and the system performs a matching process (step S202) for searching the matched image. For example, the system may provide an interface for users to input the inquiry conditions which may combines some keyboards in different fields. In step S204, the system may retrieve matched images and display the result (step S206).

To sum up the above description of the present invention, one of the objectives of the present invention is to identify the position of the magnified tissue image, and/or the original symptom image extracted from the pathological section. For example, the position of the magnified tissue image is set as an origin which may locate at (102, 154) relative to the area of original symptom. This magnified tissue image is identified by this coordinates (102, 154) in this example. Similarly, the position specified to the original symptom image relative to the pathological section is the clue to identify the original symptom image in the later search.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for identifying a pathological tissue image, comprising:
a. preparing a pathological section which is observed by an optical microscope, and a plurality of observation regions obtained therefrom;
b. selecting one of the observation regions from the pathological section, and digitizing the observation region using a digital camera to take image of the observation region, wherein the image is regarded as an original symptom image;
c. enlarging the original symptom image with a certain magnification as a magnified original image;
d. obtaining an area having a region of interest (ROI) from pathological section;
e. digitizing the area having the ROI by the digital camera as a magnified tissue image;
f. comparing the magnified tissue image with the magnified original image with the matching magnification, so as to acquire coordinates of the magnified tissue image in connection with the ROI using the matching magnification, and set the coordinates to be the coordinates of the tissue image.

2. The method of claim 1, further comprising:
calibrating the images undergoing the comparing step with essentially consistent magnification and alignment.

3. The method of claim 2, wherein the step for calibrating the images includes calibrating color, clearness, noise and orientation of the images.

4. The method of claim 1, further comprising a step of converting the tissue image into a file with DICOM format after identifying the coordinates of the image.

5. The method of claim 4, wherein data relevant to the tissue image is integrated into the DICOM-format file.

6. The method of claim 5, wherein the data relevant to the tissue image includes patient name, gender, medical history, and image title associated with the matched coordinates of the tissue image.

7. The method of claim 1, wherein the coordinates of the image is calculated by locating the features selected from the image in the comparison process.

8. The method of claim 1, wherein when the images are magnified, the magnified images need to be inserted with extra pixels by an interpolation process.

9. The method of claim 1, wherein the original symptom image is selected from the images taken by a digital camera.

10. A computer-readable medium for storing instructions of executing the method according to claim 1.
